(19) United States
(12) Patent Application Publication
(10) Pub. No.: US 2012/0259017 A1
(43) Pub. Date: Oct. 11, 2012

(54) Use of Propionic Acid as an Antimicrobial

(75) Inventors: Satish Nayak, West Des Moines, IA (US); Desiree Leach, Des Moines, IA (US)

(73) Assignee: KEMIN INDUSTRIES, INC., Des Moines, IA (US)

(21) Appl. No.: 13/444,037

(22) Filed: Apr. 11, 2012

Related U.S. Application Data
(60) Provisional application No. 61/474,082, filed on Apr. 11, 2011.

(51) Int. Cl. A01N 37/02; A01P 1/00; A01P 3/00; A01N 37/10

(52) U.S. Cl. 514/569; 514/557

(57) ABSTRACT

Propionic acid is used to curb the growth of Candida albicans, Aspergillus niger, Escherichia coli, Pseudomonas aeruginosa and Staphylococcus aureus in personal care products. Carnosic acid may be substituted for some of the propionic acid to provide a synergistic combination.

### CROSS-REFERENCE TO RELATED APPLICATIONS

This application claims priority to U.S. Patent Application Ser. No. 61/474,082, filed on Apr. 11, 2011, which is incorporated herein by this reference in its entirety.

### BACKGROUND OF THE INVENTION

The present invention relates generally to fungicides and, more specifically, to the preservation of personal care products by prevention of mold, Candida spp., as well as targeted Gram-positive and Gram-negative bacteria.

All personal care products, such as soaps, cleansers, shampoos, lotions, and the like strive to comply with the microbial contamination standards set by the United States Pharmacopeia 51 (USP51). USP51 specifies five target microorganisms to be killed or curbed by antimicrobials in personal care products. These five microorganisms are: 1. Candida albicans (ATCC #10231); 2. Aspergillus niger (ATCC #16404); 3. Escherichia coli (ATCC #8739); 4. Pseudomonas aeruginosa (ATCC #9027); and 5. Staphylococcus aureus (ATCC #6538).

A great concern for manufacturers of personal care products is the efficacy of preservation against all five USP51 targets both within 7 days and maintenance over 28 days. There are few if any single preservatives that achieve the desired broad spectrum antimicrobial properties. While the efficacy of propionic acid in curbing or killing molds is well known, it was not anticipated to have strong efficacy against Candida spp. Surprisingly, the tests reported here show that propionic acid not only curbs, but kills (reduces below readily measureable levels) all five USP51 target microorganisms.

### SUMMARY OF THE INVENTION

The present invention consists of a composition containing propionic acid or salts of propionic acid that when added to personal care cream formulations and challenged with Candida albicans, Aspergillus niger, Escherichia coli, Pseudomonas aeruginosa and Staphylococcus aureus kills all within 7 days. The propionic salt can be from any source but, in a preferred embodiment, is obtained by extracting soy glycerin via ethanol distillation, then fermenting the soy glycerin with propionii bacteria and drying the ferment. A powder composition is standardized to a desired minimum propionic salt content.

### BRIEF DESCRIPTION OF THE FIGURES

FIG. 1 is a graph of the effect of propionic acid salt on Escherichia coli.

FIG. 2 is a graph of the effect of propionic acid salt on Staphylococcus aureus.

FIG. 3 is a graph of the effect of propionic acid salt on Pseudomonas aeruginosa.

FIG. 4 is a graph of the effect of propionic acid salt on Aspergillus niger (f/k/a Aspergillus brasiliensis).

FIG. 5 is a graph of the effect of propionic acid salt on Candida albicans.

### DESCRIPTION OF THE INVENTION

The propionic acid salt used in these tests was made by the fermentation of glycerol. The primary, dominant product is propionic acid, however other compounds include acetic acid, succinic acid, n-propanol, and glycerol also may be present. Acetic acid might have some activity but the amounts are much lower in comparison to propionic acid. Any source of propionic acid may be used. In the preferred embodiment, sodium hydroxide is added to the propionic acid to created the sodium salt, however, any suitable cation could be used. A suitable source of propionic acid is the product MicroCurb™ (Kemin Industries, Inc., Des Moines, Iowa). The propionic acid is applied at level that is efficacious well below the known antimicrobial and antifungal effect of a low pH. Preferably, propionic acid is added at a level between 1000 ppm and 20,000 ppm of the personal care product being treated, more preferably between 6000 ppm and 15,000 ppm, and those skilled in the art will recognize that all values in between these listed ranges are within the scope of the invention.

In an alternative embodiment of the present invention, a source of carnosic acid is added in combination with the propionic acid to achieve a synergistic effect. Substituting some of the propionic acid with carnosic acid reduced the total amount of the combination required to have the same level of protective effect. Although any source of carnosic acid can be used, a natural extract of rosemary was used in the preferred embodiments.

Personal care products cover a wide range of products used for beautification and/or personal hygiene. Included specifically within personal care products that can be protected by the methods of the present invention are products that take the form of creams and lotions for application to the skin, hair or other portions of the body. Typically, such personal care products are an emulsion of oil and water phases and can support the growth of microorganisms.

### Example 1

### Materials and Methods

The pathogens used in the tests were obtained from commercial sources. The pathogens were harvested and adjusted to 10⁷ CFU/mL.

The personal care product used in the tests was a skin cream formulation made with natural ingredients. The ingredients in the cream (100 g) were 18 g jojoba oil (Sigma-Aldrich 59980 jojoba oil from Simmondsia chinesis), 6 g olive oil (Sigma-Aldrich O1514 olive oil), 3 g safflower oil (Sigma-Aldrich 5828 safflower oil from Cartanus linctorius seed), 15 g sunflower oil, 5 g emulsifying wax (Spectrum W1026), and 0.05 g BHT (500 ppm) in the oil phase and 1 g xanthan gum (Sigma-Aldrich G1253 xanthan gum from Xanthomonas campestris), MycoCURB® (Kemin Industries, Inc., Des Moines, Iowa), and water in the water phase. The MycoCURB was dissolved in water in a beaker and adjusted to pH 4.50 using 10% HCl. The xanthan gum was added to the beaker. The water phase and oil phase were heated separately to 80° C. in a water bath. The water phase was added to the oil phase and mixed at greater than 1800 rpm until an emulsion formed. The cream was divided into tubes.

Each tube was inoculated with the standardized microbial suspensions, using a ratio of 1 mL to 10 grams of the product so that the inoculum immediately after suspension contained 10⁶ cfu/g. The treated product was streaked on plates of growth medium appropriate for the test microorganism: E. coli and S. aureus on tryptic soy agar; P. aeruginosa on nutrient medium; and A. niger and C. albicans on Sabourand dextrose agar.

Tryptic soy agar was prepared by suspending 40 g of tryptic soy agar powder in 1 liter of purified water. The contents were mixed, heated and boiled for 1 min. to completely dissolve the powder. The medium was autoclaved at 121° C. for 20 minutes and the medium was placed in a water bath maintained at 50° C. for 1 hr. Once the contents cooled to 45-50° C. the melted poured agar was poured into Petri dishes.

Nutrient agar was prepared in the same method as tryptic soy agar, however using 8 g of nutrient agar medium powder per liter. Nutrient agar was used for the first replication of this experiment for the growth of P. aeruginosa, however; for the second replication the strain was grown on tryptic soy agar.

Sabourand dextrose agar was prepared in the same method as tryptic soy agar, however using 65 g of Sabourand dextrose agar medium powder per liter.

The inoculated plates were incubated at 25° C. The number of viable microorganisms per gram was calculated via plate count method. Counts were assessed at day 0, 2, 7, 13, and 27.

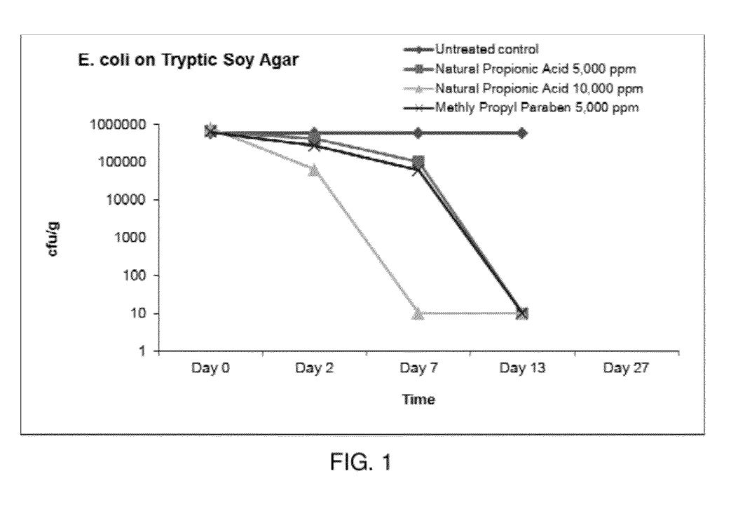

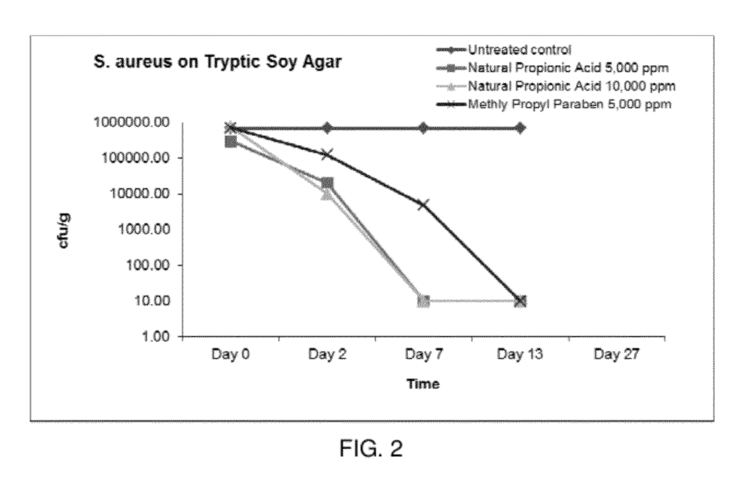

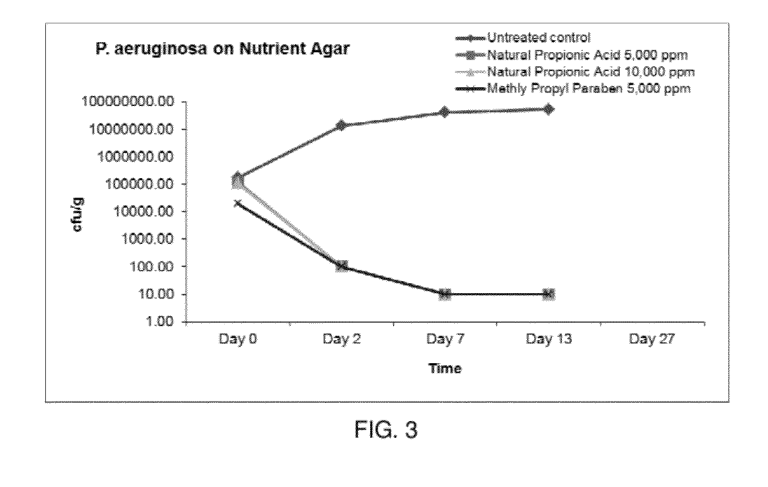

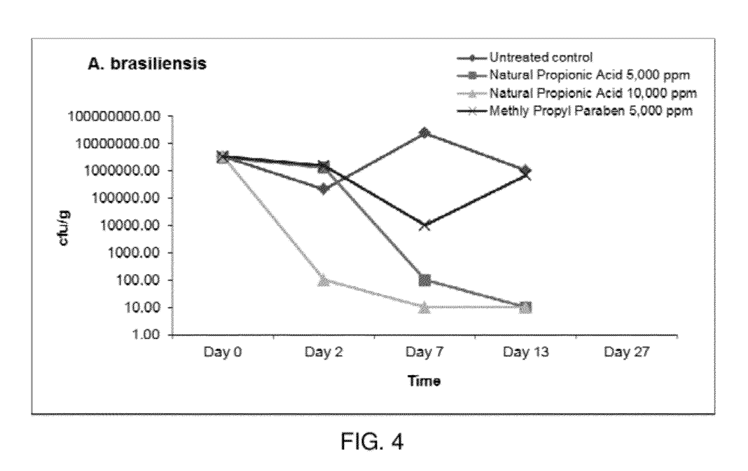

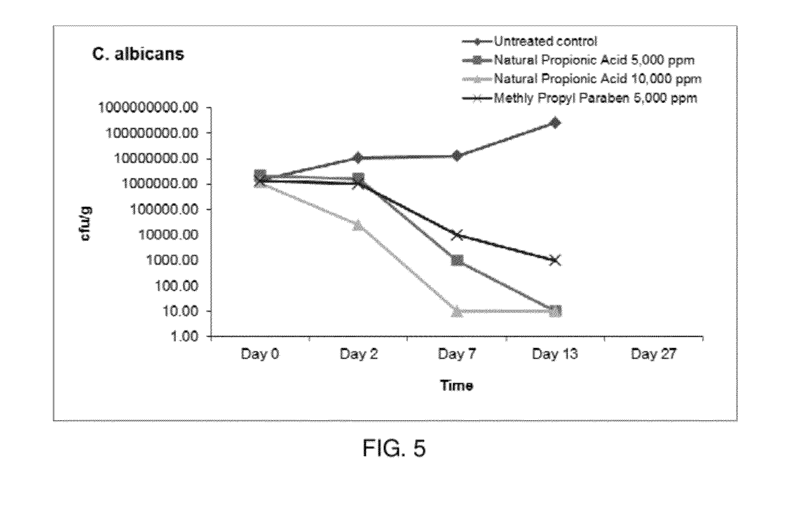

The results are presented in FIGS. 1-5.

### Discussion

The literature shows that no organic acid with only three carbons has been shown to kill Candida spp. At least six carbons and up to eleven carbons has previously been thought to be required. This was a surprise to the inventors as they were prepared to add an additional molecule to propionic acid to enable the killing of Candida albicans.

### Example 2

### Materials and Methods

MicroCurb, containing 33% propionic acid, was applied to treatments in first replication, and MicroCurb containing 41.8% propionic acid, was applied to treatments in second replication. The treatments were standardized to contain 0.5% and 1.0% natural propionic acid (NPA) in both replications.

Cream Formulation.

Aseptic techniques were followed in the preparation of the treatments by using equipment and conducting the cream formulations in a laminar flow hood. Methyl and propyl paraben were obtained from internal stocks. Jojoba oil, olive oil, safflower oil, sunflower oil, emulsifying wax, and xanthan gum were purchased from Sigma-Aldrich (St. Louis, Mo.). The recipe and procedure of making the cream formulations were as follows:

TABLE 1
Amount of ingredients used to prepare 100 g of cream with different
antimicrobials (in grams) for the first replication

| | | | | |
|---|---|---|---|---|
| | Neg- | | | 0.5% Methyl + |
| | ative | | | 0.5% Propyl |
| Ingredients | Control | 0.5% NPA | 1% NPA | Paraben |

Oil Phase

| | | | | |
|---|---|---|---|---|
| Jojoba Oil | 18 | 18 | 18 | 18 |
| Olive Oil | 6 | 6 | 6 | 6 |
| Safflower Oil | 3 | 3 | 3 | 3 |
| Sunflower Oil | 15 | 15 | 15 | 15 |
| MicroCurb | 0 | 0.76 | 1.5 | 1.5 |
| Methyl Paraben | 0 | 0 | 0 | 0.5 |
| Propyl Paraben | 0 | 0 | 0 | 0.5 |
| Emulsifying | 5 | 5 | 5 | 5 |
| Wax | | | | |

Water Phase

| | | | | |
|---|---|---|---|---|
| Xanthan Gum | 1 | 1 | 1 | 1 |
| DI Water | 52 | 51 | 50.5 | 49.5 |

TABLE 2
Amount of ingredients used to prepare 100 g of cream with different
antimicrobials (in grams) for the second replication

| | | | | |
|---|---|---|---|---|
| | Neg- | | | 0.5% Methyl + |
| | ative | | | 0.5% Propyl |
| Ingredients | Control | 0.5% NPA | 1% NPA | Paraben |

Oil Phase

| | | | | |
|---|---|---|---|---|
| Jojoba Oil | 18 | 18 | 18 | 18 |
| Olive Oil | 6 | 6 | 6 | 6 |
| Safflower Oil | 3 | 3 | 3 | 3 |
| Sunflower Oil | 15 | 15 | 15 | 15 |
| MicroCurb | 0 | 0.6 | 1.2 | 1.5 |
| Methyl Paraben | 0 | 0 | 0 | 0.5 |
| Propyl Paraben | 0 | 0 | 0 | 0.5 |
| Emulsifying | 5 | 5 | 5 | 5 |
| Wax | | | | |

Water Phase

| | | | | |
|---|---|---|---|---|
| Xanthan Gum | 1 | 1 | 1 | 1 |
| DI Water | 52 | 51.4 | 50.8 | 49.5 |

MicroCurb and water were weighed in a 250 mL beaker. After the MicroCurb was dissolved completely in water, the pH of the solution was adjusted to 4.5 with 20% hydrochloric acid solution. Xanthan Gum was then added to the beaker and mixed manually for 1-2 minutes. The oil phase (jojoba, olive, safflower, sunflower, and emulsifying wax) was weighed in a second 250 mL beaker. The oil and water phase were each heated to 80° C. in a water bath. The water phase was then poured into the oil phase quickly and the mixture was homogenized using an overhead mixer (IKA RW 20) (IKA Works, Inc., Wilmington, N.C.) at 1800 RPM until a stable emulsion was formed. Creams were transferred to sterile 50 mL conical centrifuge tubes (BD Vacutainer Labware Medical, Sparks, Md.) for inoculation.

Preparation of Inoculum.

The target microorganisms, Candida albicans (ATCC#10231); Escherichia coli (ATCC #8739); Pseudomonas aeruginosa (ATCC #9027); and Staphylococcus aureus (ATCC #6538), were obtained from internal stock culture collection stored at −80° C. Aspergillus niger (ATCC #16404) was obtained from commercial sources (ATCC, Manassas, Va.). The bacterial strains, E. coli, P. aeruginosa and S. aureus, were grown in tryptic soy broth (Bacto, BD Sciences, Sparks, Md.) incubated at 37° C. for 18-20 h. C. albicans was grown on Sabourand dextrose broth (Bacto, BD Sciences, Sparks, Md.) incubated at 25° C. for 42-46 h and A. niger was grown on Sabourand dextrose agar (Bacto, BD Sciences, Sparks, Md.) media at 25° C. for one week. The bacterial strains and C. albicans were harvested by centrifugation (5,000 RPM, 20 min), washed and resuspended in sterile saline to give the required microbial or spore count of 7-log CFU/mL. To harvest A. niger, the culture was washed with sterile saline, agitated with a sterile inoculating loop, and adjusted to 7-log CFU/mL. The microbial suspensions were counted using a Petroff-Hausser counting chamber. Populations of each strain were verified by plating on their appropriate growth medium: E. coli, S. aureus, and P. aeruginosa on tryptic soy Agar (Bacto, BD Sciences, Sparks, Md.) and A. niger and C. albicans on Sabourand dextrose agar (Bacto, BD Sciences, Sparks, Md.).

Preparation of Media.

Tryptic soy agar was prepared by suspending 40 g of tryptic soy agar powder in 1 liter of deionized tap water. The contents were mixed, heated and boiled for 1 min. to completely dissolve the powder. The media was autoclaved at 121° C. for 20 minutes and placed in a water bath maintained at 50° C. for 1 hr. Once the contents cooled to 45-50° C. the melted agar was poured into sterile Petri dishes.

Sabourand dextrose agar was prepared using the similar method as tryptic soy agar, however using 65 g of Sabourand dextrose agar media powder per liter.

Antimicrobial Preservative Testing.

Each tube was inoculated with the standardized microbial suspensions, using a ratio of 1 mL to 10 grams of the product, ensuring that the inoculum immediately after suspension would yield the target level of 6-log CFU/g cream. For every testing interval, the sample was enumerated by sampling 1 g from the original product containers, serial dilution, and streaking plates containing the appropriate growth media to the test colonization in duplicate. The inoculated plates were incubated at 25° C. for C. albicans and A. niger and 37° C. for E. coli, S. aureus, and P. aeruginosa. The number of viable microorganisms per gram was calculated via plate count method. The samples were enumerated on day 0, 2, 3, 5, 7, 14, and 28 for both replications. The original product containers were stored at 25° C. for the duration of the study.

Statistical Analysis.

The microbiological data was reported as average values and standard deviations (log CFU/g) and two separate trials for each test formulation. Differences between the experimental treatments and the control without antimicrobials were analyzed by one-way analysis of variance at each sampling interval (STATGRAPHICS® Centurion XV. Version 15.2.06. Warrenton, Va.). All statistically significant differences in the study were reported at p<0.05 level.

### Results

The creams were too viscous to enumerate below 1-log dilution such that counts at 0-log dilution could not be obtained (i.e. 1 g of the sample could not be plated directly on the media). If no colonies were observed at 1-log dilution the number of microorganisms were assumed to be less than 10 CFU/g.

Results from the two replications (Table 3 and 4) showed that the cream treatments containing the antimicrobials reduced the number of viable microorganisms when compared with the untreated sample at a faster rate. Treatments are reported by the concentration of their actives. See Tables 5-9 for data on the change in number of microorganisms as a function of time. The MicroCurb treatments (0.5% NPA and 1.0% NPA) were statistically different from the untreated sample for all five pathogens, whereas the methyl propyl paraben treatment was significantly different from the untreated sample for E. coli, P. aeruginosa, and C. albicans.

TABLE 3
Number of days required for reduction of the microorganisms
to <10 CFU/g (first replication)

| | E. | S. | P. | C. | A. |
|---|---|---|---|---|---|
| Treatment | coli | aureus | aeruginosa | albicans | niger |
| Untreated Sample | 14 | 5 | 5 | >28 | >28 |
| 0.5% NPA | 7 | 3 | 3 | 7 | 5 |
| 1.0% NPA | 7 | 3 | 3 | 5 | 3 |
| 0.5% Methyl + 0.5% | 7 | 3 | 3 | >28 | >28 |
| Propyl Paraben | | | | | |

TABLE 4
Number of days required for reduction of the microorganisms
to <10 CFU/g (second replication)

| | E. | S. | P. | C. | A. |
|---|---|---|---|---|---|
| Treatment | coli | aureus | aeruginosa | albicans | niger |
| Untreated Sample | 14 | 7 | 3 | >28 | >28 |
| 0.5% NPA | 5 | 3 | 2 | 7 | 5 |
| 1.0% NPA | 3 | 3 | 2 | 5 | 5 |
| 0.5% Methyl + 0.5% | 5 | 5 | 2 | 7 | >28 |
| Propyl Paraben | | | | | |

TABLE 5
E. coli on Tryptic Soy Agar

| | | | | |
|---|---|---|---|---|
| | Untreated | | | 0.5% Methyl + |
| Timepoint | control | 0.5% NPA | 1.0% NPA | 0.5% Propyl Paraben |

Replicate 1

| | | | | |
|---|---|---|---|---|
| Day 0 | 5.69 | 5.74 | 5.54 | 5.72 |
| Day 2 | 5.65 | 5.12 | 4.19 | 2.00 |
| Day 3 | 5.37 | 2.18 | 2.18 | 2.00 |
| Day 5 | 4.69 | 2.08 | 1.90 | 2.00 |
| Day 7 | 3.08 | 1.00 | 1.00 | 1.00 |
| Day 14 | 1.00 | 1.00 | 1.00 | 1.00 |
| Day 28 | 1.00 | 1.00 | 1.00 | 1.00 |

Replicate 2

| | | | | |
|---|---|---|---|---|
| Day 0 | 5.78 | 5.94 | 5.64 | 5.90 |
| Day 2 | 5.77 | 3.74 | 2.70 | 5.23 |
| Day 3 | 5.31 | 3.31 | 1.00 | 4.01 |
| Day 5 | 4.16 | 1.00 | 1.00 | 1.00 |
| Day 7 | 3.19 | 1.00 | 1.00 | 1.00 |
| Day 14 | | 1.00 | 1.00 | 1.00 |
| Day 28 | | 1.00 | 1.00 | 1.00 |

TABLE 6
S. aureus on Tryptic Soy Agar

| | | | | |
|---|---|---|---|---|
| | Untreated | | | 0.5% Methyl + |
| Timepoint | control | 0.5% NPA | 1.0% NPA | 0.5% Propyl Paraben |

Replicate 1

| | | | | |
|---|---|---|---|---|
| Day 0 | 5.87 | 5.80 | 5.95 | 6.01 |
| Day 2 | 5.47 | 3.00 | 3.00 | 2.00 |
| Day 3 | 3.18 | 1.00 | 1.00 | 1.00 |
| Day 5 | 1.00 | 1.00 | 1.00 | 1.00 |
| Day 7 | 1.00 | 1.00 | 1.00 | 1.00 |
| Day 14 | 1.00 | 1.00 | 1.00 | 1.00 |
| Day 28 | 1.00 | 1.00 | 1.00 | 1.00 |

Replicate 2

| | | | | |
|---|---|---|---|---|
| Day 0 | 5.72 | 5.79 | 5.73 | 5.87 |
| Day 2 | 5.24 | 2.70 | 3.18 | 3.76 |
| Day 3 | 3.86 | 1.00 | 1.00 | 2.18 |
| Day 5 | 2.85 | 1.00 | 1.00 | 1.00 |
| Day 7 | 1.00 | 1.00 | 1.00 | 1.00 |
| Day 14 | 1.00 | 1.00 | 1.00 | 1.00 |
| Day 28 | 1.00 | 1.00 | 1.00 | 1.00 |

TABLE 7
P. aeruginosa on Nutrient Agar

| | | | | |
|---|---|---|---|---|
| | Untreated | | | 0.5% Methyl + |
| Timepoint | control | 0.5% NPA | 1.0% NPA | 0.5% Propyl Paraben |

Replicate 1

| | | | | |
|---|---|---|---|---|
| Day 0 | 5.11 | 4.88 | 4.40 | 4.00 |
| Day 2 | 4.00 | 2.00 | 2.00 | 2.00 |
| Day 3 | 3.00 | 1.00 | 1.00 | 1.00 |
| Day 5 | 1.00 | 1.00 | 1.00 | 1.00 |
| Day 7 | 1.00 | 1.00 | 1.00 | 1.00 |
| Day 14 | 1.00 | 1.00 | 1.00 | 1.00 |
| Day 28 | 1.00 | 1.00 | 1.00 | 1.00 |

Replicate 2

| | | | | |
|---|---|---|---|---|
| Day 0 | 5.23 | 4.00 | 4.00 | 4.00 |
| Day 2 | 4.00 | 1.00 | 1.00 | 1.00 |
| Day 3 | 1.00 | 1.00 | 1.00 | 1.00 |
| Day 5 | 1.00 | 1.00 | 1.00 | 1.00 |
| Day 7 | 1.00 | 1.00 | 1.00 | 1.00 |
| Day 14 | 1.00 | 1.00 | 1.00 | 1.00 |
| Day 28 | 1.00 | 1.00 | 1.00 | 1.00 |

TABLE 8
C. albicans on Sabourand Dextrose Agar

| | | | | |
|---|---|---|---|---|
| | Untreated | | | 0.5% Methyl + |
| Timepoint | control | 0.5% NPA | 1.0% NPA | 0.5% Propyl Paraben |

Replicate 1

| | | | | |
|---|---|---|---|---|
| Day 0 | 5.65 | 5.68 | 5.67 | 5.68 |
| Day 2 | 6.89 | 5.64 | 4.15 | 5.79 |
| Day 3 | 7.20 | 4.95 | 2.70 | 5.10 |
| Day 5 | 8.16 | 3.81 | 1.00 | 2.00 |
| Day 7 | 7.27 | 1.00 | 1.00 | 1.00 |
| Day 14 | 7.82 | 1.00 | 1.00 | 1.00 |
| Day 28 | 7.16 | 1.00 | 1.00 | 2.23 |

Replicate 2

| | | | | |
|---|---|---|---|---|
| Day 0 | 6.09 | 6.25 | 6.21 | 6.30 |
| Day 2 | 7.39 | 6.02 | 4.18 | 6.04 |
| Day 3 | 7.39 | 5.38 | 3.70 | 5.16 |
| Day 5 | 7.09 | 3.96 | 1.00 | 2.89 |
| Day 7 | 8.69 | 1.00 | 1.00 | 1.00 |
| Day 14 | 8.69 | 1.00 | 1.00 | 1.00 |
| Day 28 | 6.81 | 1.00 | 1.00 | 1.00 |

TABLE 9
A. niger on Sabourand Dextrose Agar

| | | | | |
|---|---|---|---|---|
| | Untreated | | | 0.5% Methyl + |
| Timepoint | control | 0.5% NPA | 1.0% NPA | 0.5% Propyl Paraben |

Replicate 1

| | | | | |
|---|---|---|---|---|
| Day 0 | 6.18 | 6.32 | 6.36 | 6.47 |
| Day 2 | 6.45 | 6.34 | 6.51 | 5.92 |
| Day 3 | 6.37 | 2.00 | 1.00 | 6.05 |
| Day 5 | 5.50 | 1.00 | 1.00 | 5.95 |
| Day 7 | 5.95 | 1.00 | 1.00 | 5.69 |
| Day 14 | 6.04 | 1.00 | 1.00 | 5.48 |
| Day 28 | 6.02 | 1.00 | 1.00 | 4.85 |

Replicate 2

| | | | | |
|---|---|---|---|---|
| Day 0 | 5.45 | 5.45 | 5.34 | 5.41 |
| Day 2 | 5.46 | 5.13 | 4.00 | 5.28 |
| Day 3 | 5.56 | 3.00 | 3.00 | 5.16 |
| Day 5 | 5.30 | 1.00 | 1.00 | 5.16 |
| Day 7 | 5.49 | 1.00 | 1.00 | 4.83 |
| Day 14 | 5.49 | 1.00 | 1.00 | 4.16 |
| Day 28 | 5.54 | 1.00 | 1.00 | 3.06 |

### Discussion

Both MicroCurb treatments were able to reduce the number of microorganisms to less than 10 CFU/g and maintain this efficacy for the duration of the 28-day study. Methyl propyl paraben was unable reduce to <10 CFU/g for C. albicans in the first replication; however, it did reach <10 CFU/g by day-28 in the second replication. In both replicates the methyl propyl paraben treatment was unable to reduce to <10 CFU/g for A. niger by the end of the study. Moreover, the methyl propyl paraben treatment was only significantly different from the untreated sample for three of the five pathogens (E. coli, P. aeruginosa, and C. albicans); whereas, the MicroCurb treatments (formulated to both 0.5% and 1.0% NPA in the creams) were statistically different from the untreated sample for all pathogens. Based on the results, the MicroCurb treatments can provide more antimicrobial protection than the methyl propyl paraben treatment which is currently used in the personal care industry. MicroCurb, formulated at a concentration of 1.0% NPA was the most effective treatment as it required the least amount of time (in both replicates) for the reduction of microorganisms to less than 10 CFU/g.

The sensitivity of bacteria with respect to low-pH environments has been well documented. Although the untreated creams when challenged with the bacterial strains showed a reduction of microorganisms due to acidity of the cream at pH 4.5, the MicroCurb treatments were able to reduce the number of viable microorganisms at a much faster rate, as seen in tables. From the antimicrobial efficacy studies, it was demonstrated that by applying efficacious amounts of MicroCurb™ (0.5 and 1.0% NPA) in personal care/cosmetic applications can reduce Candida albicans (ATCC#10231); Aspergillus niger (ATCC #16404); Escherichia coli (ATCC #8739); Pseudomonas aeruginosa (A'ICC #9027); and Staphylococcus aureus (ATCC #6538).

### Example 3

### Materials and Methods

Preparation of MicroCurb™.

MicroCurb, containing 33% propionic acid, was applied to the treatments in first replication, and MicroCurb containing 41.8% propionic acid, was applied to the treatments in second replication. The treatments were standardized to contain 0.5% and 1.0% natural propionic acid (NPA) in both replications. An alternative natural source of carnosic acid was added to formulations to determine if it had any activity.

Cream Formulation.

Aseptic techniques were followed in the preparation of the treatments by using equipment and conducting the cream formulations in a laminar flow hood. Rosemary extracts (RE) are known in the industry as sources of carnosic acid. Rosamox™ Liquid (Kemin Industries, Inc., Des Moines, Iowa), is an RE which is a formulation of sunflower (Helianthus annuus) oil and an extract of rosemary (Rosmarinus officinalis) which contains 4.51% carnosic acid, and was obtained internally. Methyl and propyl paraben, antimicrobials used in the personal care market, served as the positive control and were obtained internally. Jojoba oil, olive oil, safflower oil, sunflower oil, emulsifying wax, and xanthan gum were purchased from Sigma-Aldrich (St. Louis, Mo.). The recipe and procedure of making the cream formulations were as follows:

TABLE 10
Amount of ingredients used to prepare 100 g of cream with
different antimicrobials (in grams) for first replication

| | | | | |
|---|---|---|---|---|
| | Neg- | | | 0.5% Methyl + |
| | ative | 0.25% NPA + | 0.5% NPA + | 0.5% Propyl |
| Ingredients | Control | 0.25% RE | 0.25% RE | Paraben |

Oil Phase

| | | | | |
|---|---|---|---|---|
| Jojoba Oil | 18 | 18 | 18 | 18 |
| Olive Oil | 6 | 6 | 6 | 6 |
| Safflower Oil | 3 | 3 | 3 | 3 |
| Sunflower Oil | 15 | 15 | 15 | 15 |
| RE | 0 | 0.25 | 0.25 | 0.25 |
| MicroCurb | 0 | 0.76 | 1.5 | 1.5 |
| Methyl Paraben | 0 | 0 | 0 | 0.5 |
| Propyl Paraben | 0 | 0 | 0 | 0.5 |
| Emulsifying | 5 | 5 | 5 | 5 |
| Wax | | | | |

Water Phase

| | | | | |
|---|---|---|---|---|
| Xanthan Gum | 1 | 1 | 1 | 1 |
| DI Water | 52 | 51 | 50.3 | 49.3 |

TABLE 11
Amount of ingredients used to prepare 100 g of cream with
different antimicrobials (in grams) for second replication

| | | | | |
|---|---|---|---|---|
| | Neg- | | | 0.5% Methyl + |
| | ative | 0.25% NPA + | 0.5% NPA + | 0.5% Propyl |
| Ingredients | Control | 0.25% RE | 0.25% RE | Paraben |

Oil Phase

| | | | | |
|---|---|---|---|---|
| Jojoba Oil | 18 | 18 | 18 | 18 |
| Olive Oil | 6 | 6 | 6 | 6 |
| Safflower Oil | 3 | 3 | 3 | 3 |
| Sunflower Oil | 15 | 15 | 15 | 15 |
| RE | 0 | 0.25 | 0.25 | 0.25 |
| MicroCurb | 0 | 0.6 | 1.2 | 1.5 |
| Methyl Paraben | 0 | 0 | 0 | 0.5 |
| Propyl Paraben | 0 | 0 | 0 | 0.5 |
| Emulsifying | 5 | 5 | 5 | 5 |
| Wax | | | | |

Water Phase

| | | | | |
|---|---|---|---|---|
| Xanthan Gum | 1 | 1 | 1 | 1 |
| DI Water | 52 | 51.2 | 50.6 | 49.3 |

MicroCurb and water were weighed in a 250 mL beaker. After the MicroCurb was dissolved completely in water, the pH of the solution was adjusted to 4.5 with 20% hydrochloric acid solution. Xanthan gum was then added to the beaker and mixed manually for 1-2 minutes. The oil phase (jojoba, olive, safflower, sunflower, RE and emulsifying wax) was weighed in a second 250 mL beaker. The oil and water phase were each heated to 80° C. in a water bath. The water phase was then poured into the oil phase quickly and the mixture was homogenized using an overhead mixer (IKA RW 20) (IKA Works, Inc., Wilmington, N.C.) at 1800 RPM until a stable emulsion was formed. Creams were transferred to sterile 50 mL conical centrifuge tubes (BD Vacutainer Labware Medical, Sparks, Md.) for inoculation.

Preparation of Inoculum.

The target microorganisms, Candida albicans (ATCC#10231); Escherichia coli (ATCC #8739); Pseudomonas aeruginosa (A'ICC#9027); and Staphylococcus aureus (ATCC#6538), were obtained from internal stock culture collection stored at −80° C. Aspergillus niger (ATCC#16404) was obtained from commercial sources (ATCC, Manassas, Va.). The bacterial strains, E. coli, P. aeruginosa and S. aureus, were grown in tryptic soy broth (Bacto, BD Sciences, Sparks, Md.) incubated at 37° C. for 18-20 h. C. albicans was grown on Sabourand dextrose broth (Bacto, BD Sciences, Sparks, Md.) incubated at 25° C. for 42-46 h and A. niger was grown on Sabourand dextrose agar (Bacto, BD Sciences, Sparks, Md.) media at 25° C. for one week. The bacterial strains and C. albicans were harvested by centrifugation (5,000 RPM, 20 min), washed and resuspended in sterile saline to give the required microbial or spore count of 7-log CFU/mL. To harvest A. niger, the culture was washed with sterile saline, agitated with a sterile inoculating loop, and adjusted to 7-log CFU/mL. The microbial suspensions were counted using a Petroff-Hausser counting chamber. Populations of each strain were verified by plating on their appropriate growth medium: E. coli, S. aureus, and P. aeruginosa on tryptic soy agar (Bacto, BD Sciences, Sparks, Md.) and A. niger and C. albicans on Sabourand dextrose agar (Bacto, BD Sciences, Sparks, Md.).

Preparation of Media.

Tryptic soy agar was prepared by suspending 40 g of tryptic soy agar powder in 1 liter of deionized tap water. The contents were mixed, heated and boiled for 1 min. to completely dissolve the powder. The media was autoclaved at 121° C. for 20 minutes and placed in a water bath maintained at 50° C. for 1 hr. Once the contents cooled to 45-50° C. the melted agar was poured into sterile Petri dishes.

Sabourand dextrose agar was prepared using the similar method as tryptic soy agar, however using 65-g of Sabourand dextrose agar media powder per liter.

Antimicrobial Preservative Testing.

Each tube was inoculated with the standardized microbial suspensions, using a ratio of 1 mL to 10 grams of the product, ensuring that the inoculum immediately after suspension would yield the target level of 6-log CFU/g cream. For every testing interval, the sample was enumerated by sampling 1 g from the original product containers, serially diluting, and streaking plates containing the appropriate growth media to the test colonization in duplicate. The inoculated plates were incubated at 25° C. for C. albicans and A. niger and 37° C. for E. coli, S. aureus, and P. aeruginosa. The number of viable microorganisms per gram was calculated via plate count method. The samples were enumerated on day 0, 2, 3, 5, 7, 14, and 28 for both replications.

Statistical Analysis.

The microbiological data was reported as average values and standard deviations (log CFU/g) and two separate trials for each test formulation. Differences between the experimental treatments and the control without antimicrobials were analyzed by one-way analysis of variance at each sampling interval (STATGRAPHICS® Centurion XV. Version 15.2.06. Warrenton, Va.). All statistically significant differences in the study were reported at p<0.05 level.

### Results

The creams were too viscous to enumerate below 1-log dilution such that counts at O-log dilution could not be obtained (i.e. 1-g of the sample could not be plated directly on the media). If no colonies were observed at 1-log dilution the number of microorganisms was assumed to be less than 10 CFU/g.

Results from the two replications (Table 12 and 13) showed that the cream treatments containing the antimicrobials reduced the number of viable microorganisms when compared with the negative control at a faster rate. Treatments were reported as the concentrations of their actives. See Tables 14-18 for the data on the change of number of microorganisms as a function of time. The 0.5% NPA+0.25% RE treatment was significantly different from the untreated sample for all pathogens. 0.25% NPA+0.25% RE was significantly different from the untreated sample for only pathogens S. aureus, C. albicans, and A. niger, and 0.5% methyl+0.5% propyl paraben was significantly different from the untreated sample for all pathogens except for A. niger.

TABLE 12
Number of days required for reduction of the microorganisms
to <10 CFU/g (first replication)

| | E. | S. | P. | C. | A. |
|---|---|---|---|---|---|
| Treatment | coli | aureus | aeruginosa | albicans | niger |
| Untreated Sample | 14 | 5 | 5 | >28 | >28 |
| 0.25% NPA + 0.25% RE | 7 | 3 | 3 | 7 | 14 |
| 0.5% NPA + 0.25% RE | 7 | 3 | 3 | 7 | 14 |
| 0.5% Methyl + 0.5% | 7 | 3 | 3 | >28 | >28 |
| Propyl Paraben | | | | | |

TABLE 13
Number of days required for reduction of the microorganisms
to <10 CFU/g (second replication)

| | E. | S. | P. | C. | A. |
|---|---|---|---|---|---|
| Treatment | coli | aureus | aeruginosa | albicans | niger |
| Untreated Sample | 14 | 7 | 3 | >28 | >28 |
| 0.25% NPA + 0.25% RE | 5 | 5 | 2 | 14 | 5 |
| 0.5% NPA + 0.25% RE | 3 | 3 | 2 | 7 | 5 |
| 0.5% Methyl + 0.5% | 5 | 5 | 2 | 7 | >28 |
| Propyl Paraben | | | | | |

TABLE 14
E. coli on Tryptic Soy Agar

| | | | | |
|---|---|---|---|---|
| | Un- | | | 0.5% Methyl + |
| | treated | 0.25% NPA + | 0.50% NPA + | 0.5% Propyl |
| Timepoint | control | 0.25% RE | 0.25% RE | Paraben |

Replicate 1

| | | | | |
|---|---|---|---|---|
| Day 0 | 5.69 | 5.75 | 5.77 | 5.72 |
| Day 2 | 5.65 | 5.41 | 5.13 | 2.00 |
| Day 3 | 5.37 | 3.82 | 2.00 | 2.00 |
| Day 5 | 4.69 | 1.78 | 2.04 | 2.00 |
| Day 7 | 3.08 | 1.00 | 1.00 | 1.00 |
| Day 14 | 1.00 | 1.00 | 1.00 | 1.00 |
| Day 28 | 1.00 | 1.00 | 1.00 | 1.00 |

Replicate 2

| | | | | |
|---|---|---|---|---|
| Day 0 | 5.78 | 5.82 | 5.88 | 5.90 |
| Day 2 | 5.77 | 4.74 | 3.88 | 5.23 |
| Day 3 | 5.31 | 3.29 | 1.00 | 4.01 |
| Day 5 | 4.16 | 1.00 | 1.00 | 1.00 |
| Day 7 | 3.19 | 1.00 | 1.00 | 1.00 |
| Day 14 | | 1.00 | 1.00 | 1.00 |
| Day 28 | | 1.00 | 1.00 | 1.00 |

TABLE 15
S. aureus on Tryptic Soy Agar

| | | | | |
|---|---|---|---|---|
| | Un- | | | 0.5% Methyl + |
| | treated | 0.25% NPA + | 0.50% NPA + | 0.5% Propyl |
| Timepoint | control | 0.25% RE | 0.25% RE | Paraben |

Replicate 1

| | | | | |
|---|---|---|---|---|
| Day 0 | 5.87 | 5.94 | 5.91 | 6.01 |
| Day 2 | 5.47 | 2.40 | 2.00 | 2.00 |
| Day 3 | 3.18 | 1.00 | 1.00 | 1.00 |
| Day 5 | 1.00 | 1.00 | 1.00 | 1.00 |
| Day 7 | 1.00 | 1.00 | 1.00 | 1.00 |
| Day 14 | 1.00 | 1.00 | 1.00 | 1.00 |
| Day 28 | 1.00 | 1.00 | 1.00 | 1.00 |

Replicate 2

| | | | | |
|---|---|---|---|---|
| Day 0 | 5.72 | 5.66 | 5.64 | 5.87 |
| Day 2 | 5.24 | 3.42 | 2.00 | 3.76 |
| Day 3 | 3.86 | 1.30 | 1.00 | 2.18 |
| Day 5 | 2.85 | 1.00 | 1.00 | 1.00 |
| Day 7 | 1.00 | 1.00 | 1.00 | 1.00 |
| Day 14 | 1.00 | 1.00 | 1.00 | 1.00 |
| Day 28 | 1.00 | 1.00 | 1.00 | 1.00 |

TABLE 16
P. aeruginosa on Nutrient Agar

| | | | | |
|---|---|---|---|---|
| | Un- | | | 0.5% Methyl + |
| | treated | 0.25% NPA + | 0.50% NPA + | 0.5% Propyl |
| Timepoint | control | 0.25% RE | 0.25% RE | Paraben |

Replicate 1

| | | | | |
|---|---|---|---|---|
| Day 0 | 5.11 | 4.95 | 4.60 | 4.00 |
| Day 2 | 4.00 | 2.00 | 2.00 | 2.00 |
| Day 3 | 3.00 | 2.00 | 1.00 | 1.00 |
| Day 5 | 1.00 | 1.00 | 1.00 | 1.00 |
| Day 7 | 1.00 | 1.00 | 1.00 | 1.00 |
| Day 14 | 1.00 | 1.00 | 1.00 | 1.00 |
| Day 28 | 1.00 | 1.00 | 1.00 | 1.00 |

Replicate 2

| | | | | |
|---|---|---|---|---|
| Day 0 | 5.23 | 4.00 | 4.00 | 4.00 |
| Day 2 | 4.00 | 1.00 | 1.00 | 1.00 |
| Day 3 | 1.00 | 1.00 | 1.00 | 1.00 |
| Day 5 | 1.00 | 1.00 | 1.00 | 1.00 |
| Day 7 | 1.00 | 1.00 | 1.00 | 1.00 |
| Day 14 | 1.00 | 1.00 | 1.00 | 1.00 |
| Day 28 | 1.00 | 1.00 | 1.00 | 1.00 |

TABLE 17
C. albicans on Sabourand Dextrose Agar

| | | | | |
|---|---|---|---|---|
| | Un- | | | 0.5% Methyl + |
| | treated | 0.25% NPA + | 0.50% NPA + | 0.5% Propyl |
| Timepoint | control | 0.25% RE | 0.25% RE | Paraben |

Replicate 1

| | | | | |
|---|---|---|---|---|
| Day 0 | 5.65 | 5.67 | 5.47 | 5.68 |
| Day 2 | 6.89 | 5.74 | 5.47 | 5.79 |
| Day 3 | 7.20 | 5.58 | 5.03 | 5.10 |
| Day 5 | 8.16 | 5.23 | 3.18 | 2.00 |
| Day 7 | 7.27 | 4.07 | 1.00 | 1.00 |
| Day 14 | 7.82 | 4.07 | 1.00 | 1.00 |
| Day 28 | 7.16 | 1.00 | 1.00 | 2.23 |

Replicate 2

| | | | | |
|---|---|---|---|---|
| Day 0 | 6.09 | 6.24 | 6.29 | 6.30 |
| Day 2 | 7.39 | 6.34 | 6.16 | 6.04 |
| Day 3 | 7.39 | 6.20 | 6.05 | 5.16 |
| Day 5 | 7.09 | 6.20 | 4.99 | 2.89 |
| Day 7 | 8.69 | 6.20 | 1.00 | 1.00 |
| Day 14 | 8.69 | 1.00 | 1.00 | 1.00 |
| Day 28 | 6.81 | 1.00 | 1.00 | 1.00 |

TABLE 18
A. niger on Sabourand Dextrose Agar

| | | | | |
|---|---|---|---|---|
| | Un- | | | 0.5% Methyl + |
| | treated | 0.25% NPA + | 0.50% NPA + | 0.5% Propyl |
| Timepoint | control | 0.25% RE | 0.25% RE | Paraben |

Replicate 1

| | | | | |
|---|---|---|---|---|
| Day 0 | 6.18 | 6.24 | 6.36 | 6.47 |
| Day 2 | 6.45 | 6.24 | 6.19 | 5.92 |
| Day 3 | 6.37 | 6.24 | 2.00 | 6.05 |
| Day 5 | 5.50 | 5.27 | 1.00 | 5.95 |
| Day 7 | 5.95 | 3.00 | 1.00 | 5.69 |
| Day 14 | 6.04 | 1.00 | 1.00 | 5.48 |
| Day 28 | 6.02 | 1.00 | 1.00 | 4.85 |

Replicate 2

| | | | | |
|---|---|---|---|---|
| Day 0 | 5.45 | 5.36 | 5.50 | 5.41 |
| Day 2 | 5.46 | 5.46 | 5.15 | 5.28 |
| Day 3 | 5.56 | 4.17 | 3.00 | 5.16 |
| Day 5 | 5.30 | 1.00 | 1.00 | 5.16 |
| Day 7 | 5.49 | 1.00 | 1.00 | 4.83 |
| Day 14 | 5.49 | 1.00 | 1.00 | 4.16 |
| Day 28 | 5.54 | 1.00 | 1.00 | 3.06 |

### Discussion

Both treatments (0.25% NPA+0.25% RE and 0.5% NPA+0.25% RE) were able to reduce the number of microorganisms to less than 10 CFU/g and maintain this efficacy for the duration of the 28-day study. Methyl propyl paraben was unable to reduce to <10 CFU/g for C. albicans in the first replication, however did reduce to <10 CFU/g by day-28 in the second replication. In both replicates the methyl propyl paraben treatment was unable to reduce to <10 CFU/g for A. niger by the end of the study. Based on the results, the MicroCurb/RE treatments can provide more antimicrobial protection than the methyl propyl paraben treatment which is currently used in the personal care industry. The 0.5% NPA+0.25% RE was the only treatment significantly different from the untreated sample for all pathogens and required the least amount of time (in both replicates) for the reduction to <10 cfu/g for all pathogens. Therefore, 0.5% NPA+0.25% RE was the most effective treatment in the study.

Using 0.25% RE in combination with MicroCurb at lower inclusion rates (0.25% and 0.5% NPA) showed similar efficacy to the prior study conducted with MicroCurb alone at 0.5% and 1.0% NPA. RE, in concentrations of 0.25% to 1.0% showed no efficacy against the five target microorganisms in a previous study. Based upon these results and the current study, MicroCurb and RE have synergistic properties that allow for the preservation of skin creams.

The sensitivity of bacteria with respect to low-pH environments has been well documented. Although the untreated creams when challenged with the bacterial strains showed a reduction of microorganisms due to acidity of the cream at pH 4.5, the MicroCurb/RE treatments were able to reduce the number of viable microorganisms at a much faster rate, as seen in the tables. It can be concluded that the application of efficacious amounts of MicroCurb and RE in personal care/cosmetic applications, can reduce Candida albicans (ATCC#10231); Aspergillus niger (ATCC #16404); Escherichia coli (ATCC #8739); Pseudomonas aeruginosa (A'ICC #9027); and Staphylococcus aureus (ATCC #6538).

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

We claim:

1. A method of curbing the growth of Candida albicans, Aspergillus niger, Escherichia coli, Pseudomonas aeruginosa and Staphylococcus aureus in personal care products comprising applying an efficacious amount of propionic acid.

2. A method as defined in claim 1, wherein the efficacious amount of propionic acid is between 1000 ppm and 20,000 ppm.

3. A method as defined in claim 1, wherein carnosic acid is substituted for some of the propionic acid.

4. A method for reducing in claim 3 the total amount of acids in an efficacious amount, comprising substituting a selected amount of propionic acid with a lesser amount of carnosic acid.

5. A method of curbing the growth of USP51 microorganisms in a personal care product, comprising the steps of:
(a) formulating an oil phase;
(b) adding an efficacious amount of propionic acid;
(c) formulating a water phase;
(d) optionally adding an emulsifier; and
(e) forming an emulsified personal care product.

6. A method as defined in claim 5, wherein the personal care product is selected from the group consisting of lotions and creams.

7. A method of reducing the populations of Candida albicans, Aspergillus niger, Escherichia coli, Pseudomonas aeruginosa and Staphylococcus aureus below 10 CFU/g in personal care products and maintain said reduced population level for at least 28 days, comprising applying an efficacious amount of propionic acid.

8. A method as defined in claim 7, wherein the efficacious amount of propionic acid is between 1000 ppm and 20,000 ppm.

9. A method as defined in claim 7, wherein carnosic acid is substituted for some of the propionic acid.

10. A method for reducing in claim 9 the total amount of acids in an efficacious amount, comprising substituting a selected amount of propionic acid with a lesser amount of carnosic acid.
